(19) United States
(12) Patent Application Publication
(10) Pub. No.: US 2006/0044581 A1
(43) Pub. Date: Mar. 2, 2006

(54) Method for providing image reproduction of digital pictures

(76) Inventors: Barry Richard Cavill, Lexington, KY (US); Mark Joseph Edwards, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/932,985

(22) Filed: Sep. 2, 2004

(51) Int. Cl. G06K 15/00; G06F 15/00

(52) U.S. Cl. 358/1.12; 358/1.18

(57) ABSTRACT

A method for providing image reproduction of digital pictures in an imaging apparatus having a print engine, a scanner and an input device, includes printing a proof index sheet containing a plurality of thumbnail images corresponding to a plurality of digital pictures and having a unique identifying indicia; printing an order form separate from the proof index sheet, the order form including the unique identifying indicia and at least one selectable processing instruction associated with a corresponding digital picture; feeding the completed order form through the imaging apparatus to scan the order form completed with processing instructions; and generating a printed image for at least one of the plurality of digital pictures in accordance with the processing instructions entered on the order form.

### BACKGROUND OF THE INVENTION

1. Field of the Invention

The present invention relates to an imaging apparatus, and, more particularly, to a method for providing image reproduction of digital pictures.

2. Description of the Related Art

Images taken by digital cameras are typically stored in a removable memory associated with the camera, for example, a memory card or disk media. These images can be subsequently modified by the user using built-in features of the digital camera. The images can also be downloaded onto a typical personal computer, and modified using commercially available specialized software. In either case, the images can then be printed using conventional electrostatic or ink jet printers, preferably in a photo-quality print mode. Some digital cameras allow the user to connect the camera directly to a printer, either via a cable or docking station. Alternatively, some digital cameras include a removable memory card which may be loaded into a card reader. The card reader may be formed integral with the printer, or may be a separate device which is configured to be attached to the printer.

Printing in a standalone mode has the advantage of printing without the need for a personal computer, or for a display screen attached to the printer for viewing the images. However, in photo imaging it is desirable to display the contents of the memory to allow the user to select the images that the user wishes to print.

In one prior method, for example, images are retrieved from the memory by manually entering a sequence of keystrokes on a keyboard, such as a user interface, but such a method is prone to user error.

In another method, for example, a combination thumbnail proof/order sheet is printed by an all-in-one (AIO) unit, which includes a printer and conventional scanner. The user then selects photos for printing by filling in selection circles or check boxes directly on the combination thumbnail proof/order sheet, and inserts the combination thumbnail proof/order sheet back into the AIO unit, which scans the combination thumbnail proof/order sheet and prints the selected images. However, marking the desired photos and print options directly on the combination thumbnail proof/order sheet limits the further usefulness of the sheet. For example, if the user changes their mind, or desires additional prints after the initial combination thumbnail proof/order sheet has been processed, then the user may have to print an entirely new combination thumbnail proof/order sheet, thereby requiring use of the additional ink, typically color ink, required to print the image portion of the combination thumbnail proof/order sheet again. Also, for example, if the combination thumbnail proof/order sheet is inserted improperly, the wrong image might be printed, or some other adverse action might take place. Given the high cost of photo quality paper, the cost of ink, and the time required for printing photo quality images, it is desirable to avoid printing the entire combination thumbnail proof/order sheet, or printing the wrong image.

What is needed in the art is a method for providing image reproduction of digital pictures, and which facilitates the selection of images to be printed, without the use of a combination thumbnail proof/order sheet.

### SUMMARY OF THE INVENTION

The present invention provides a method for providing image reproduction of digital pictures, and which facilitates the selection of images to be printed, without the use of a combination thumbnail proof/order sheet.

The invention, in one form thereof, relates to a method for providing image reproduction of digital pictures in an imaging apparatus having a print engine, a scanner and an input device. The method includes printing a proof index sheet containing a plurality of thumbnail images corresponding respectively to each of a plurality of digital pictures stored in a memory, each of the plurality of thumbnail images having a unique identifying indicia; printing an order form separate from the proof index sheet, the order form including the unique identifying indicia for each of the plurality of thumbnail images, each of the unique identifying indicia having associated therewith at least one selectable processing instruction associated with a corresponding digital picture of the plurality of digital pictures, the at least one selectable processing instruction being selected by inserting a mark at a designated location on the order form; completing the order form with processing instructions by inserting the mark at the designated location for each of the plurality of digital pictures for which imaging processing is desired; feeding the order form through the imaging apparatus to scan with the scanner the order form completed with the processing instructions; and generating a printed image for at least one of the plurality of digital pictures in accordance with the processing instructions entered on the order form.

The present invention, in another form thereof, is directed to an apparatus having a print engine, a scanner, and an input device, each communicatively coupled to a controller. The controller executes program instructions to perform a method for providing image reproduction of digital pictures, the method includes printing a proof index sheet containing a plurality of thumbnail images corresponding respectively to each of a plurality of digital pictures stored in a memory, each of the plurality of thumbnail images having a unique identifying indicia; printing an order form separate from the proof index sheet, the order form including the unique identifying indicia for each of the plurality of thumbnail images, each of the unique identifying indicia having associated therewith at least one selectable processing instruction associated with a corresponding digital picture of the plurality of digital pictures, the at least one selectable processing instruction being selected by inserting a mark at a designated location on the order form; processing the order form, having been completed by a user with processing instructions by inserting the mark at the designated location for each of the plurality of digital pictures for which imaging processing is desired, through the imaging apparatus to scan with the scanner the order form completed with the processing instructions; and generating a printed image for at least one of the plurality of digital pictures in accordance with the processing instructions entered on the order form.

An advantage of the present invention is that it may be implemented in a low cost imaging apparatus operating in a standalone mode.

Another advantage of the present invention is that the cost and/or use of a display screen may be avoided.

Another advantage of the present invention is that the need for manual entry of a key sequence to retrieve or select an image is avoided.

Another advantage of the present invention is that marking directly on a separate order form to select the image permits reuse of the proof index sheet.

Yet another advantage of the present invention is that the order form sheet includes an orientation marking, allowing for ease of use, and leading to the prevention of mistakes in printing images.

### BRIEF DESCRIPTION OF THE DRAWINGS

The above-mentioned and other features and advantages of this invention, and the manner of attaining them, will become more apparent, and the invention will be better understood by reference to the following description of embodiments of the invention taken in conjunction with the accompanying drawings, wherein:

FIG. 1 is a diagrammatic depiction of an imaging system that utilizes the present invention.

FIG. 2 is an illustration of a proof index sheet in accordance with the present invention.

FIG. 3 is an illustration of an order form in accordance with the present invention.

FIG. 4 is a flowchart depicting a method in accordance with the present invention.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION OF THE INVENTION

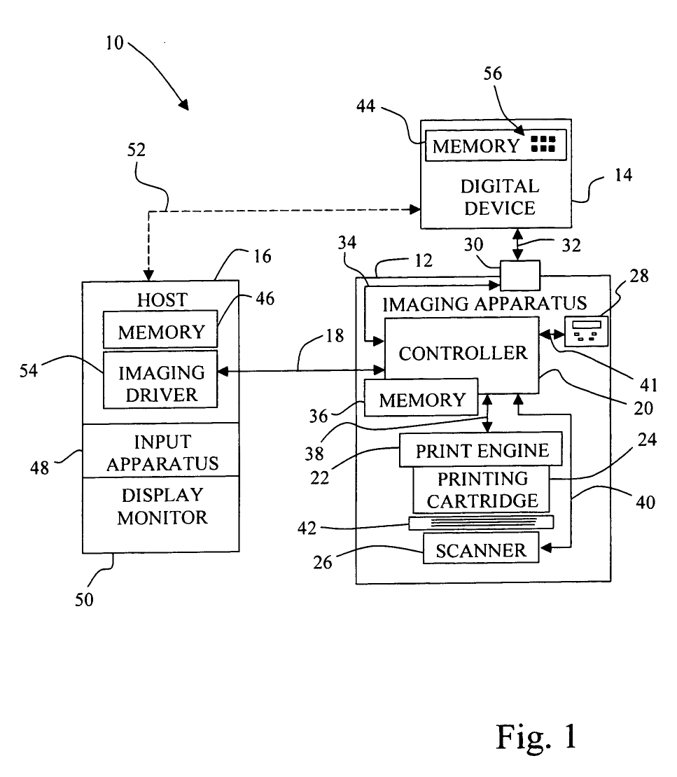

Referring now to the drawings, and particularly to FIG. 1, there is shown a diagrammatic depiction of an imaging system 10 embodying the present invention. Imaging system 10 includes an imaging apparatus 12, a digital device 14, and a host 16. Imaging apparatus 12 communicates with host 16 via a communications link 18. As used herein, the term “communications link” is used to generally refer to structure which facilitates electronic communication between two components, and may operate using wired or wireless technology.

Imaging apparatus 12 can be, for example, an ink jet printer and/or copier, an electrophotographic printer and/or copier, or an all-in-one (AIO) unit that includes a printer, a scanner, and possibly a fax unit. Imaging apparatus 12 includes a controller 20, a print engine 22, a printing cartridge 24, a scanner 26, and a user interface 28. In accordance with the present invention, user interface 28 may be a simple device, since it need not possess the ability to view digital pictures.

Imaging apparatus 12 also includes an interface 30 for facilitating communication with digital device 14 via a communication link 32. Interface 30 communicates with controller 20 via a communication link 34. Interface 30 and communication link 32 may provide communication between imaging apparatus 12 and digital device 14, respectively, via a typical communication protocol, such as a universal serial bus (USB). Alternatively, interface 30 and communications link 32 may form a dedicated docking station and operate using a proprietary protocol. As a further alternative, interface 30 may be a memory card reader formed integral with imaging apparatus 12, or may be an external memory card reader that is attached to imaging apparatus 12.

Controller 20 includes a processor unit and associated memory 36, and may be formed as one or more Application Specific Integrated Circuits (ASIC). Alternatively, memory 36 may be in the form of a separate electronic memory, a hard drive, a CD drive, or any memory device convenient for use with controller 20. Controller 20 may be a printer controller, a scanner controller, or may be a combined printer and scanner controller. Controller 20 communicates with print engine 22 via a communications link 38. Controller 20 communicates with scanner 26 via a communications link 40. User interface 28 is communicatively coupled to controller 20 via a communications link 41. Controller 20 serves to process print data and to operate print engine 22 during printing, as well at to operate scanner 26 and process data obtained via scanner 26.

In the context of the examples for imaging apparatus 12 given above, print engine 22 can be, for example, an ink jet print engine, a color electrophotographic print engine or thermal transfer engine, configured for forming an image on a substrate 42, such as a sheet of paper, transparency or fabric. As an ink jet print engine, for example, print engine 22 operates printing cartridge 24 to eject ink droplets onto substrate 42 in order to reproduce text and/or images. As an electrophotographic print engine, for example, print engine 22 causes printing cartridge 24 to deposit toner onto substrate 42, which is then fused to substrate 42 by a fuser (not shown), in order to reproduce text and/or images.

Scanner 26 is a conventional scanner, such as a sheet feed or flat bed scanner. Alternatively, scanner 26 may be any suitable sensor capable of scanning, e.g. an alignment sensor for aligning a printhead of imaging apparatus 12, such as a printhead associated with printing cartridge 24.

Digital device 14 includes a memory 44, and may be, for example, a digital camera having a memory or a video camera having a memory. Alternatively, digital device 14 may be a memory card reader, which includes a slot for receiving memory 44. As a further alternative, digital device 14 with memory 44 may be a floppy drive, a hard drive, a CD drive, a DVD drive, a memory card, or any digital device capable of storing images and communicating with imaging apparatus 12. Thus, when digital device 14 is in communication with imaging apparatus 12 via interface 30 and communication link 32, imaging apparatus 12 has access to memory 44. Such access may be direct, such as in the case that digital device 14 is a memory card, or indirect, such as in the case that digital device 14 is a digital camera.

Host 16, which may be optional, may be, for example, a personal computer, including memory 46, an input apparatus 48, such as a keyboard, and a display monitor 50. Digital device 14 optionally may be coupled to host 16 via a communication link 52, depicted as a dashed line. Host 16 further includes a processor, input/output (I/O) interfaces, memory, such as RAM, ROM, NVRAM, and at least one mass data storage device, such as a hard drive, a CD-ROM and/or a DVD unit.

During operation, host 16 includes in its memory a software program including program instructions that function as an imaging driver 54, e.g., printer/scanner driver software, for imaging apparatus 12. Imaging driver 54 is in communication with controller 20 of imaging apparatus 12 via communications link 18. Imaging driver 54 facilitates communication between imaging apparatus 12 and host 16, and may provide formatted print data to imaging apparatus 12, and more particularly, to print engine 22, to print an image. Alternatively, however, all or a portion of imaging driver 54 may be located in controller 20 of imaging apparatus 12.

In some circumstances, it is desirable to operate imaging apparatus 12 without host 16, for example, in a standalone mode. In a standalone operating mode, imaging apparatus 12 is capable of functioning without host 16. For example, a user of imaging apparatus 12 may take some digital pictures with digital device 14, which stores the digital pictures in memory 44. After taking the digital pictures, the user may desire to quickly and easily work with digital pictures obtained from digital device 14 without using host 16. Also, a user may not have access to or own a computer such as host 16. Accordingly, the present invention allows a user to perform actions on digital pictures obtained by or stored in digital device 14, using imaging apparatus 12 in a standalone mode. As such, imaging apparatus 12 may communicate with digital device 14, via interface 30 and communication link 32, including accessing memory 44 that stores a plurality of digital pictures 56 as image files. Digital pictures 56 may be, for example, digital photographs or computer generated images that were previously stored in memory 44.

The plurality of digital pictures 56 are transferred or copied from memory 44, in whole or in part, to a memory associated with imaging apparatus 12, such as memory 36. The transfer may be made, for example, by accessing a transfer function on user interface 28 or digital device 14 that is facilitated by controller 20. This allows imaging apparatus 12 to perform actions with respect to the plurality of digital pictures 56. Alternatively, imaging apparatus 12 may perform actions with respect to the plurality of digital pictures 56 simply by controller 20 accessing memory 44 without transferring the plurality of digital pictures 56.

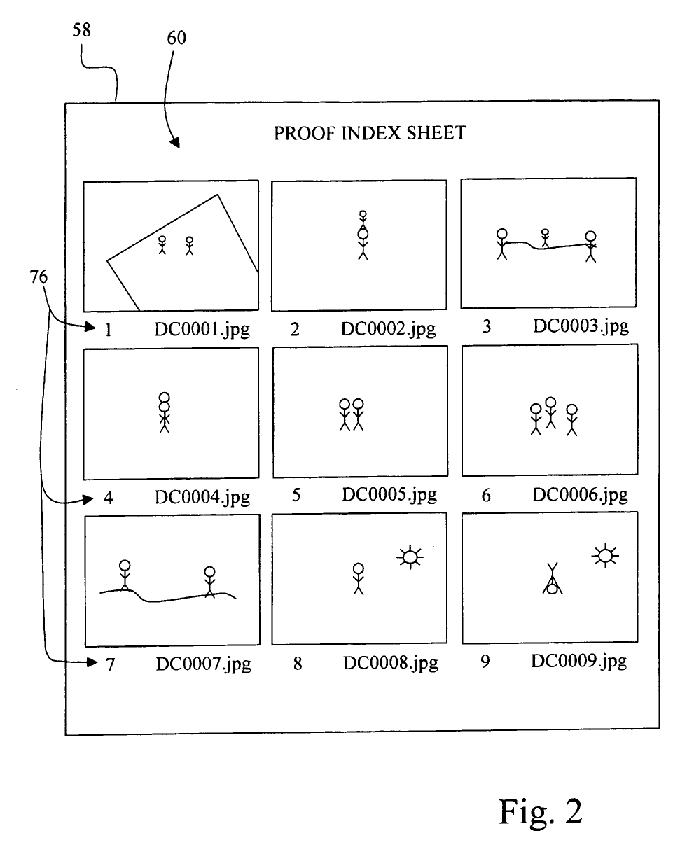

FIG. 2 shows an exemplary proof index sheet 58 that includes a plurality of thumbnail images 60, respectively corresponding to the plurality of digital pictures 56 present in the image files stored in memory 44. In this example, proof index sheet 58 includes nine thumbnail images each with a unique identifying indicia 76, e.g., consecutive numerals 1-9. Of course, other alphanumeric characters, codes and/or symbols may be used as a unique identifier for the corresponding thumbnail image. In addition, each of the plurality of thumbnail images 60 may include a file designation, e.g., DC0001.jpg, DC0002.jpg, etc., indicating the file name of the corresponding thumbnail image, and in this example, also indicating the file format, e.g., jpg indicating a jpeg image file format.

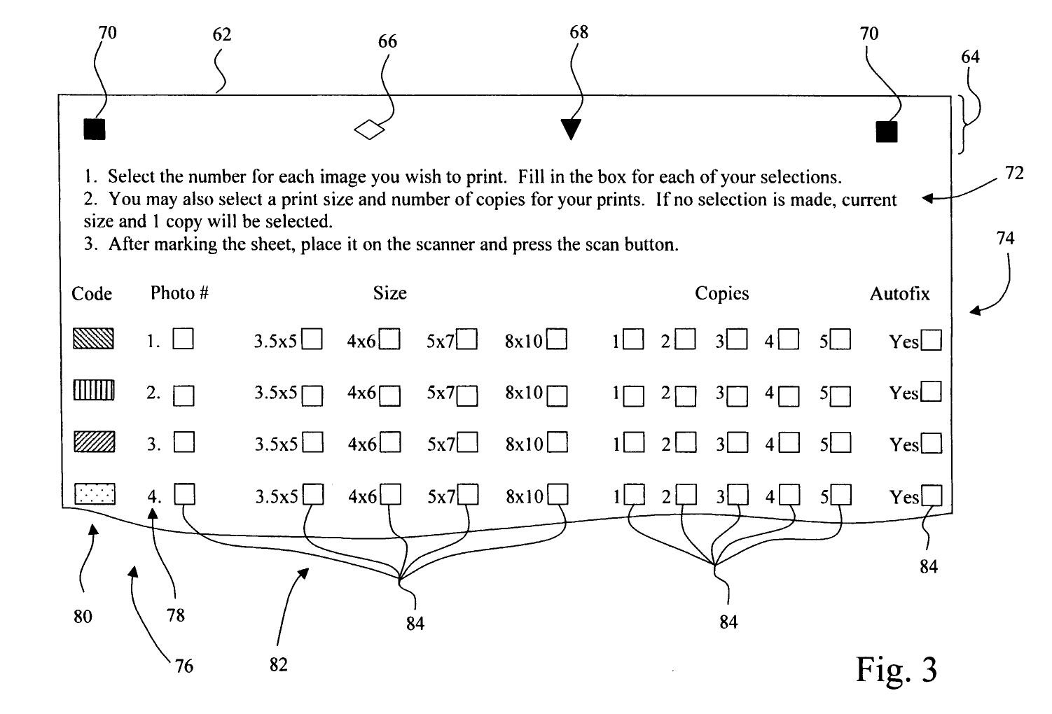

FIG. 3 shows a portion of an exemplary order form 62. A top margin 64 of order form 62 includes an identifying symbol 66, which in this example is shown as an open diamond, to identify order form 62 as such to imaging apparatus 12. In other words, when identifying symbol 66 is read by scanner 26 when processing order form 62, imaging apparatus 12 recognizes the sheet of media as order form 62.

Top margin 64 of order form 62 also includes an orientation symbol 68, which in this example is shown as a solid triangle, which is read by scanner 26 when processing order form 62 so that imaging apparatus 12 can determine the orientation of order form 62. As such, the orientation of order form 62 may be determined automatically by imaging apparatus 12 based on the orientation of orientation symbol 68.

Top margin 64, as well as the lower margin (not shown), of order form 62 may further include corner symbols 70, shown in this example as solid squares, used to identify the four corners of order form 62. Corner symbols 70 facilitate the correct scanning of order form 62 by identifying to scanner 26 the corners of order form 62.

Below top margin 64 of order form 62 is a set of printed user instructions 72 which will guide a user through the task of filling out order form 62. In addition, user instructions 72 indicate to the user how to process order form 62 through imaging apparatus 12 once the user has completed marking order form 62.

A central region 74 of order form 62 includes unique identifying indicia 76 respectively corresponding to each of the plurality of thumbnail images 60 of proof index sheet 58. Each unique identifying indicia 76 on order form 62 may include, for example, a human perceptible indicia 78, e.g., numerals 1, 2, 3, 4, . . . , and/or a machine readable code 80. Referring again to FIG. 2, the unique identifying indicia 76 on proof index sheet 58 is in the form of the human perceptible indicia. In this example, machine readable code 80 may be in the form of a rectangular box with a unique fill pattern that is discernable by scanner 26. Alternatively, for example, machine readable code 80 may be a bar code, or other coded indicia.

Each of the unique identifying indicia 76 has associated therewith at least one selectable processing instruction 82 associated with a corresponding digital picture of the plurality of digital pictures 56. In this example, such processing instruction 82 may include one or more of size, number of copies, and whether Autofix is desired. Autofix, for example, may correspond to a predetermined processing feature, e.g., red-eye reduction, contrast control, etc. Each selectable processing instruction 82 is selected by inserting a designation mark at a particular designated location of the plurality of designated locations 84 on order form 62. In this example, the designated area is in the form of a geometric object, e.g., an open square, that is to be substantially filled with the mark.

Although only certain exemplary processing instructions 82 are shown on order form 62, it is to be understood that processing instructions 82 may include other instructions other than those specifically shown, such as for example, print quality settings, such as multi-pass printing, print resolution, color, back and white, or other color-related settings; page layout for printing one image or several images on a page; and an output type, e.g., a negative image.

Various commercially available algorithms may be used for detecting identifying symbol 66, orientation symbol 68, corner symbols 70, identifying indicia 76 and/or designation marks in designated locations 84. For example, scanner 26, in the form of a conventional scanner, may use optical character recognition (OCR) software and/or bar code reading software residing in memory 36 of controller 20.

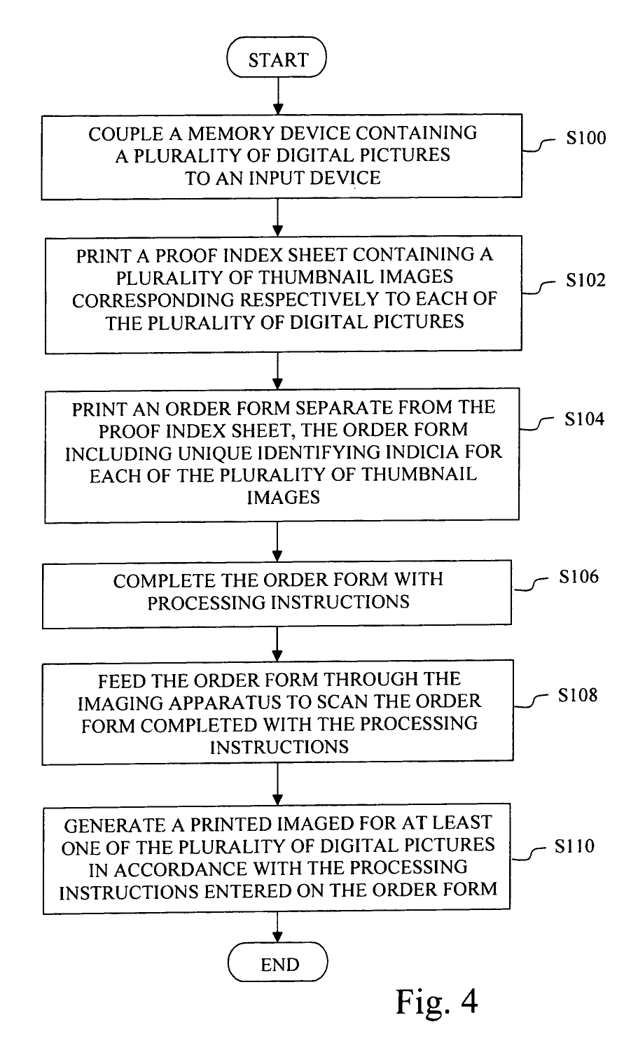

FIG. 4 is a flowchart depicting a method for providing image reproduction of digital pictures in imaging apparatus 12 having print engine 22, scanner 26 and input device, such as interface 30, in accordance with the present invention. As set forth above, each of print engine 22, scanner 26 and interface 30 may be communicatively coupled to controller 20. In implementing the method of FIG. 4, controller 20 may execute program instructions to perform the method for providing image reproduction of digital pictures, as set forth in the steps below.

At step S100, a memory device, such as memory 44 containing a plurality of digital pictures 56, is coupled to interface 30. In turn, controller 20 reads memory 44.

At step S102, proof index sheet 58 containing a plurality of thumbnail images 60 corresponding respectively to each of the plurality of digital pictures 56 is printed by imaging apparatus 12. Each of the plurality of thumbnail images 60 has a unique identifying indicia 76 (see FIG. 2).

At step S104, order form 62 separate from proof index sheet 58 is printed by imaging apparatus 12. Order form 62 includes the unique identifying indicia 76 for each of the plurality of thumbnail images 60 (see FIG. 3), and may include both a human perceptible indicia 78 and a machine readable code 80. Each of the unique identifying indicia 76 has associated therewith at least one selectable processing instruction 82 associated with a corresponding digital picture of said plurality of digital pictures 56. At least one selectable processing instruction is selected by inserting a mark at a designated location 84 on order form 62.

In one embodiment, the number of copies of order form 62 may be selected, for example, by entering the number of copies via user interface 28. However, in the absence of such an entry imaging apparatus 12 may default to a predetermined number of copies of order form 62, such as for example, one copy.

At step S106, order form 62 is completed with processing instructions 82 by inserting a mark at the designated location 84 for each of the plurality of digital pictures 56 for which imaging processing is desired.

At step S108, order form 62 is fed through imaging apparatus 12 to scan with scanner 26 the order form 62 completed with processing instructions 82. Also, identifying symbol 66 is read by scanner 26 and controller 20 to verify that the processed sheet is in fact order form 62. In addition, orientation symbol 68 is read by scanner 26 and controller 20 to determine the orientation of order form 62. Corner symbols 70 may also be read to determine the corners of order form 62. Scanner 26 and controller 20 process the processing instructions 82 as marked by the user in the designated locations 84 of order form 62.

At step S110, a printed imaged for at least one of the plurality of digital pictures 56 is generated by print engine 22 in accordance with the processing instructions 82 entered on order form 62.

Steps S104 through S110 may be repeated by imaging apparatus 12. For example, multiple order forms may be printed, completed and processed that relate to a single set of thumbnail images 60 on proof index sheet 58. Alternatively, steps S108 and S110 may be repeated for the same order form 62. For example, the same order form 62 may be processed multiple times.

While this invention has been described with respect to exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for providing image reproduction of digital pictures in an imaging apparatus having a print engine, a scanner and an input device, comprising:
printing a proof index sheet containing a plurality of thumbnail images corresponding respectively to each of a plurality of digital pictures stored in a memory, each of said plurality of thumbnail images having a unique identifying indicia;
printing an order form separate from said proof index sheet, said order form including said unique identifying indicia for each of said plurality of thumbnail images, each of said unique identifying indicia having associated therewith at least one selectable processing instruction associated with a corresponding digital picture of said plurality of digital pictures, said at least one selectable processing instruction being selected by inserting a mark at a designated location on said order form;
completing said order form with processing instructions by inserting said mark at said designated location for each of said plurality of digital pictures for which imaging processing is desired;
feeding said order form through said imaging apparatus to scan with said scanner said order form completed with said processing instructions; and
generating a printed image for at least one of said plurality of digital pictures in accordance with said processing instructions entered on said order form.

2. The method of claim 1, wherein each said unique identifying indicia on said proof index sheet comprises a human perceptible indicia.

3. The method of claim 2, wherein said human perceptible indicia is a printed character.

4. The method of claim 1, wherein each said unique identifying indicia on said order form comprises a human perceptible indicia.

5. The method of claim 4, wherein said each said unique identifying indicia on said order form further comprises a machine readable code.

6. The method of claim 1, wherein said order form includes an identifying symbol to identify said order form as such to said imaging apparatus.

7. The method of claim 1, wherein said order form includes an orientation symbol to identify an orientation of said order form to said imaging apparatus.

8. The method of claim 1, wherein said order form includes a plurality of corner symbols for identifying corners of said order form.

9. The method of claim 1, wherein said order form includes user instructions on how to complete said order form and process said order form through said imaging apparatus.

10. The method of claim 1, wherein each said designated location is a geometric object that is to be substantially filled with said mark.

11. The method of claim 1, further comprising coupling a device containing said memory to said input device.

12. The method of claim 1, comprising printing and processing multiple order forms which are related to a single set of said plurality of thumbnail images.

13. The method of claim 1, wherein the act of feeding said order form is repeated a plurality of times, resulting in a corresponding repetition of the act of generating said printed image.

14. An apparatus having a print engine, a scanner, and an input device, each communicatively coupled to a controller, said controller executing program instructions to perform a method for providing image reproduction of digital pictures, said method comprising:
printing a proof index sheet containing a plurality of thumbnail images corresponding respectively to each of a plurality of digital pictures stored in a memory, each of said plurality of thumbnail images having a unique identifying indicia;
printing an order form separate from said proof index sheet, said order form including said unique identifying indicia for each of said plurality of thumbnail images, each of said unique identifying indicia having associated therewith at least one selectable processing instruction associated with a corresponding digital picture of said plurality of digital pictures, said at least one selectable processing instruction being selected by inserting a mark at a designated location on said order form;
processing said order form, having been completed by a user with processing instructions by inserting said mark at said designated location for each of said plurality of digital pictures for which imaging processing is desired, through said imaging apparatus to scan with said scanner said order form completed with said processing instructions; and
generating a printed image for at least one of said plurality of digital pictures in accordance with said processing instructions entered on said order form.

15. The apparatus of claim 14, wherein each said unique identifying indicia on said proof index sheet comprises a human perceptible indicia.

16. The apparatus of claim 15, wherein said human perceptible indicia is a printed character.

17. The apparatus of claim 14, wherein each said unique identifying indicia on said order form comprises a human perceptible indicia.

18. The apparatus of claim 17, wherein said each said unique identifying indicia on said order form further comprises a machine readable code.

19. The apparatus of claim 14 wherein said order form includes an identifying symbol to identify said order form as such to said imaging apparatus.

20. The apparatus of claim 14, wherein said order form includes an orientation symbol to identify an orientation of said order form to said imaging apparatus.

21. The apparatus of claim 14, wherein said order form includes a plurality of corner symbols for identifying corners of said order form.

22. The apparatus of claim 14, wherein said order form includes user instructions on how to complete said order form and process said order form through said imaging apparatus.

23. The apparatus of claim 14, comprising printing and processing multiple order forms which are related to a single set of said plurality of thumbnail images.

24. The apparatus of claim 14, wherein the act of processing said order form is repeated a plurality of times, resulting in a corresponding repetition of the act of generating said printed image.
